(19) United States
(12) Patent Application Publication
(10) Pub. No.: US 2002/0170426 A1
(43) Pub. Date: Nov. 21, 2002

(54) Pneumatic cylinder for railroad track switch operator

(76) Inventor: James D. Braatz, Greenfield, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 09/858,854

(22) Filed: May 16, 2001

(51) Int. Cl. F16J 15/18

(52) U.S. Cl. 92/165 R

(57) ABSTRACT

A easily rebuildable pneumatic cylinder for a railroad track switch operator utilizes a fiber-reinforced resin composite cylinder tube and a piston wear band of a composite material. The cylinder is easily disassembled for replacement of all of the seals and the rod bearing, along with the cylinder tube and wear band. All wear and replacement parts are identically used in both common types of pneumatic cylinders in present use.

### BACKGROUND OF THE INVENTION

The present invention pertains to a pneumatic operator for a railroad track switch and, more particularly, to an improved pneumatic cylinder for such an operator providing universal replacement for existing cylinders in an assembly which is quickly and economically rebuildable on site.

Railroad track switch operators or switch machines of the prior art are powered by a number of different types of actuators. Pneumatic cylinders and hydraulic cylinders are commonly used, with the piston rod ends of such cylinders operatively connected to the switch points to selectively move the points between the two positions. Electric motor and fluid motor-driven actuators are also used. In addition, many switch operators also provide the capability for alternate manual operation.

In the United States, pneumatic operators are commonly used and comprise two basic types. The differences between these two types of pneumatic operators include the manner in which the pneumatic cylinder is mounted with respect to the other components of the switch operator and the basic construction of the cylinder itself. Both types of pneumatic switch machines uses a cast iron cylinder housing in which the nose end of the cylinder is an integral part of the casting. In order to rebuild this cylinder, the nose through which the piston rod extends must be first rebored for the replacement rod bearing bushing and, because concentricity is difficult to maintain, reassembly after rebuilding typically results in considerable leakage and loss of time. In addition, these cylinders must be lubricated regularly and are subject to premature failure if not properly maintained. These cylinders also utilize a piston that is of a multi-piece construction. The piston seals or packings are difficult to orient properly during assembly and often are found not to properly seat and to leak. The rod seals at the nose of cylinder are also difficult to install and remove and are also a source of high shaft friction. The piston rod wiper seal is fastened with a snap ring that provides less than adequate holding power and thus does not adequately prevent the ingress of dirt into the cylinder. Finally, the rubber seals are not chemically compatible with the cylinder environment, for example, the prior art seals are attacked by alcohol which is used to eliminate moisture from the compressed air.

Attempts have been made to substitute more conventional pneumatic cylinder constructions for cast iron cylinders. However, these off-the-shelf cylinders cannot be easily rebuilt and, as a result, they are simply replaced and discarded.

There is a need, therefore, for a reliable pneumatic cylinder for the harsh environment of a railroad switch operator that can be easily, effectively and quickly rebuilt in the field. To provide such a cylinder that is also virtually maintenance free would also be very desirable.

### SUMMARY OF THE INVENTION

In accordance with the present invention, a pneumatic cylinder is provided for a railroad track switch operator that is capable of being easily and quickly rebuilt in the field and, with only two part changes, can be used in either of the two most common types of switch machines using pneumatic cylinder actuators. Further, this cylinder is adapted for direct field replacement of prior art cast iron cylinders and both types utilize the same direct mount cylinder head and control valve for operating air distribution to the cylinder.

Thus, the universal and easily rebuildable pneumatic cylinder of the present invention includes a field-replaceable cylinder tube of a plastic composite material, a back end cap and a nose end cap closing the opposite ends of the cylinder tube, said caps having opposed annular bosses sized to be concentrically received in one end of the tube; a plurality of tie rods interconnecting the end caps; a one-piece piston mounted to reciprocate within the cylinder tube and including a piston rod extending axially through a bore in the nose end cap; a replaceable annular wear band mounted in a recess in the periphery of the piston, said wear band also made of a composite plastic material; and a plurality of replaceable sealing rings for each of the respective interfaces between (a) the cylinder tube and the end cap bosses, (b) the OD of the piston and the ID of the tube, and (c) the nose end cap bore and the piston rod. The assembly also includes a replaceable composite plastic rod bearing mounted in a bore in the nose end cap.

The plurality of replaceable sealing rings preferably comprises (a) a pair of D-ring seals for each of the nose and back end cap bosses, (b) a pair of packing ring seals, disposed in an annular groove in the piston on each side of the wear band, (c) a rod seal mounted in a counterbore in the nose end cap bore, and (d) a piston rod wiper seal recessed in the axially outer face of the nose end cap bore.

The assembly also includes a connector on the outer end of the piston rod for operative connection to a switch mechanism to move a track switch point between two positions corresponding to extended and retracted piston positions. In one embodiment, a signal generator is attached to the piston and a piston sensor is mounted on the outside of the cylinder to sense the position and to generate a signal representative of the piston positions. The signal generator preferably comprises a magnetic material attached to the piston head and the sensor comprises a proximity switch.

The back end cap for the cylinder may be selected from a pair of back end caps that have different lengths in the direction of the cylinder axis to accommodate either of the two common types of pneumatically operated switch machines. A common cylinder head is adapted to mount directly on either of said back end caps to direct compressed air from a supply to the cylinder.

### BRIEF DESCRIPTION OF THE DRAWINGS

FIGS. 1 and 2 are isometric views of the two common types of pneumatic cylinders utilizing the rebuilding assembly and method of the present invention.

FIG. 3 is an exploded view of the cylinders shown in FIGS. 1 and 2 showing both the common parts and the differing parts.

FIG. 4 is a vertical section through the cylinder showing the arrangement of the common parts.

FIG. 5 is an exploded view of the cylinder shown in FIG. 4.

### DETAILED DESCRIPTION OF THE PREFERRED EMBODIMENTS

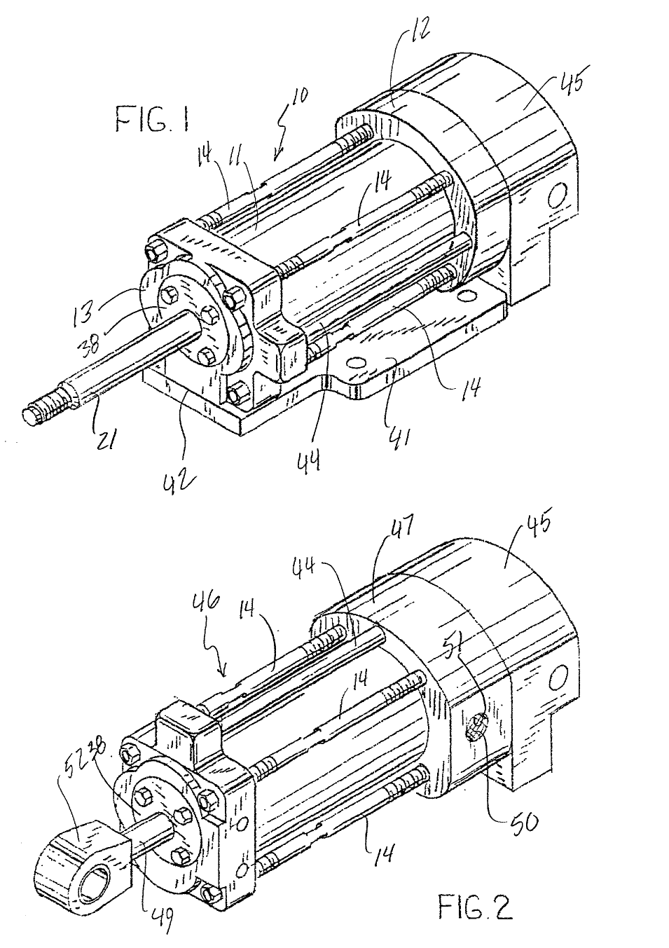

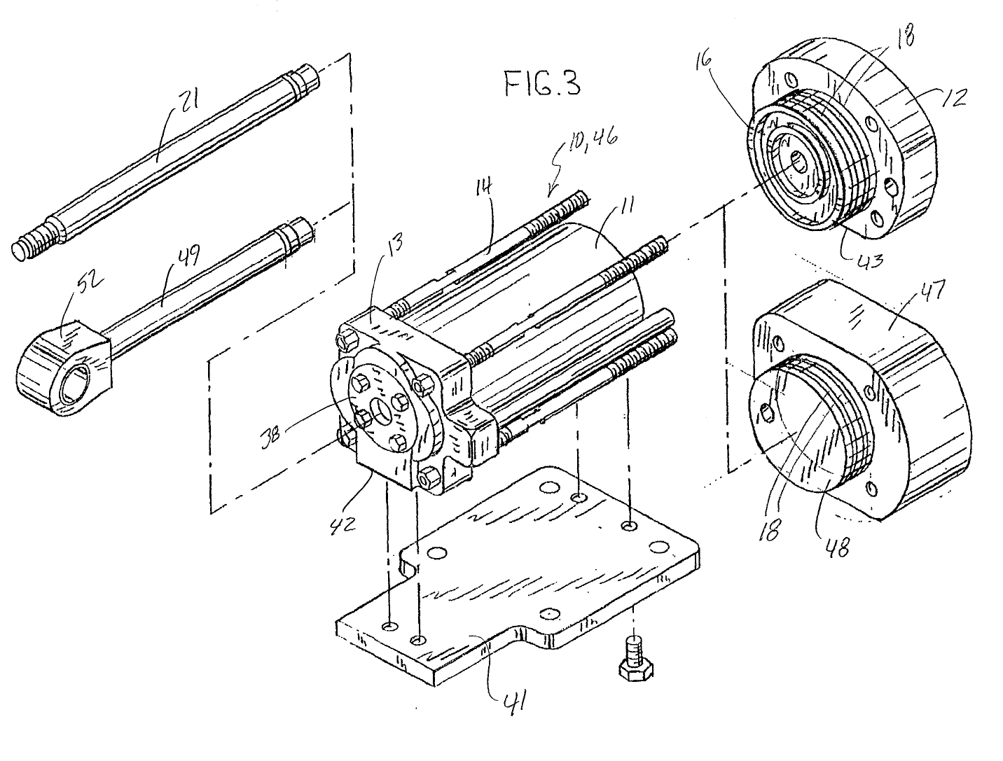

Referring first to FIGS. 1, 3 and 4, an easily rebuildable pneumatic cylinder 10 for one type of track switch operator utilizes a cylinder tube 11 made of a fiber-reinforced plastic resin composite material. The cylinder tube 11 is mounted between an enclosing back end cap 12 and a nose end cap 13. The assembly is held together with four axially extending tie rods 14, each secured with a nut and lock washer pair 15. Each of the back and nose end caps 12 and 13 includes an annular boss 16 and 17, respectively, which is received in one end of the cylinder tube 11 during assembly. Each of the bosses 16 and 17 includes a pair of D-ring seals 18 set in axially spaced annular grooves in the surface of the boss.

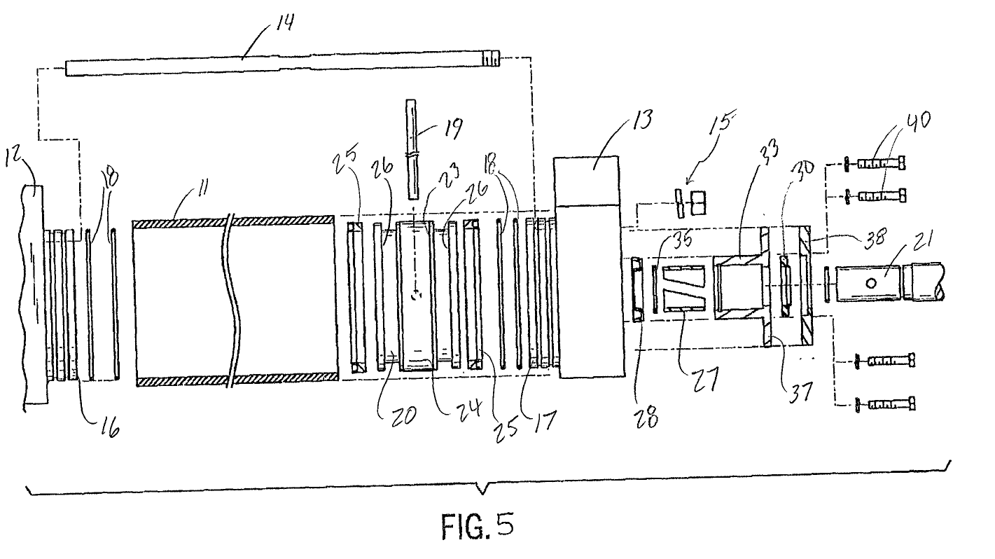

Referring also to FIG. 5, a piston 20 is mounted for reciprocal movement in the cylinder tube 11 and has a piston rod 21 demountably attached centrally to it, as with a cross pin 19. The piston rod 21 extends axially through a center bore 22 in the nose end cap 13. The piston 20 is of a unitary construction, preferably either steel or cast iron, and is provided with a wide annular recess 23 in which is seated a replaceable annular wear band 24. The wear band is made of a plastic material, preferably a fiber-reinforced plastic resin composite. The surface-to-surface contact between the ID of the cylinder tube 11 and the OD of the wear band 24 has been found to provide an excellent low friction, high wear life interface for low maintenance operation. The main piston seal is provided by a pair of oppositely disposed packing ring seals 25 disposed in annular grooves 26 on either side of the wear band 24. The bore 22 in the nose end cap 13, which is preferably made of steel, is provided with a replaceable reinforced plastic composite rod bearing 27, such as a glass-filled nylon. A piston rod seal 28 is positioned adjacent the rod bearing on the axial inner end thereof and a rod wiper seal 30 is positioned on the axial outer face of the nose end cap 13.

In rebuilding the cylinder 10, no machining is required and the cylinder may be disassembled and rebuilt on site. In the rebuilding process, the composite tube 11 and wear band 24 are replaced, as are the D-ring seals 18, the packing ring seals 25, the rod seal 28 and the wiper seal 30. The reinforced plastic rod bearing 27 is also replaced.

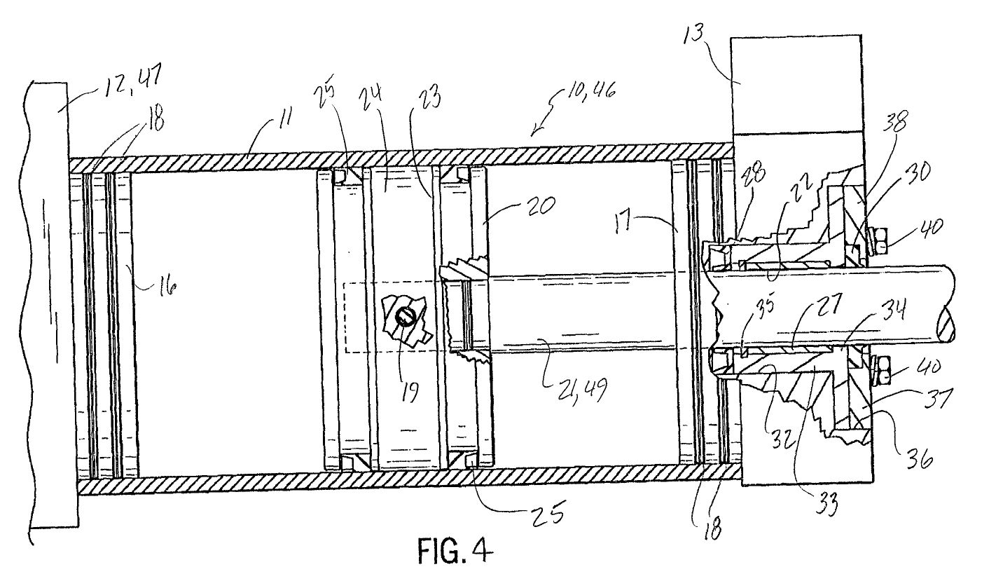

Referring particularly to FIGS. 4 and 5, the rod bearing and seal assembly is shown in detail. A deep first counterbore 32 extends from the outer face of the nose end cap 13 axially into the annular boss 17. The piston rod seal 28 is located in the bottom of the first counterbore 32. The rod bearing 27 is held in the ID of a flanged insert 33 where one end of the bearing is captured by a reduced diameter end flange 34 and the opposite end is held by a snap ring 35. The subassembly of the flanged insert 33, bearing 27 and snap ring 35 is inserted into the first counterbore 32 after the rod seal 28, and the main end flange 37 of the insert 33 is received in a shallow second counterbore 36 in the face of the nose cap 13. The rod wiper seal 30 is then placed over the outer end of the piston rod 21 and held against the outside face of the flanged insert 33 with a recessed keeper plate 38. The keeper plate is also received in the second counterbore 36 and is secured to the main end flange 37 of the insert 33 with a number of machine screws 40.

All of the seals 18, 25, 28 and 30 are made of a synthetic material, such as a urethane, which is inert to the contaminants and solvents normally encountered in use. These seals need only be greased lightly upon assembly and no relubrication whatever is required during their full service life. Preliminary tests have indicated a normal wear life far in excess of the prior art cast iron cylinders using rubber sealing rings.

The cylinder 10 includes a mounting plate 41 that is bolted to respective flats 42 and 43 machined on the surfaces of the nose end cap 13 and back end cap 12. Operating air pressure is supplied to the rod end of the cylinder 10 by an air line 44 extending between the back end cap 12 and the nose end cap 13. Operating air is supplied to the cylinder via a cylinder head 45 bolted directly to the end face of the back end cap 12. The cylinder head 45 is preferably of the type disclosed in my copending U.S. application Ser. No. 09/643,711, filed on Sep. 1, 2000, and entitled “Railroad Track Switch Operator”, the disclosure of which is incorporated herein by reference.

Another type of cylinder 46, also commonly used in pneumatic operated switch machines, is shown in FIG. 2. This cylinder 46 is identical in all respects to the cylinder 10 described above, except that it does not utilize a mounting plate 41 and it utilizes a back end cap 47 and a piston rod 49 of a slightly different construction. However, the back end cap 47 has an integral annular boss 48 adapted to utilize the same D-ring seals 18 as in the previously described cylinder. Thus, to rebuild either of cylinders 10 or 46, the wear and other replaceable parts are identical, namely, the cylinder tube 11 and wear band 24, the D-ring seals 18, the piston packing ring seals 25, the rod seal 28, the wiper seal 30 and the rod bearing 27. As indicated above, no machining whatever is necessary in the rebuilding process.

Furthermore, the back end cap 47 of the cylinder 46 is adapted to utilize the same cylinder head 45 described above.

The switch machine which utilizes this type of cylinder 46 includes a cylinder mounting pin 50 that extends through a through bore 51 in the back end cap 47. At the opposite end of the cylinder 46, the piston rod 49 is provided with a rod end bearing 52 for attachment to a clevis pin (not shown) in the switch machine.

I claim:

1. A universal, easily rebuildable pneumatic cylinder for a railroad track switch operator comprising:
a cylinder tube of a plastic composite material;
a back end cap closing one end of the cylinder tube and a nose end cap closing the other end of the tube, said caps having opposed annular bosses sized to be concentrically received in an end of the tube;
a plurality of tie rods interconnecting the end caps and the tube;
a piston mounted for reciprocal movement in said cylinder tube and having a piston rod extending axially through a bore in the nose end cap;
a replaceable annular wear band mounted in an annular recess in the periphery of the piston, said wear band made of a composite plastic material; and,
a plurality of replaceable sealing rings for the respective interfaces between the cylinder tube and the end cap bosses, the OD of the piston and the ID of the tube, and the nose end cap bore and the piston rod.

2. The invention as set forth in claim 1 further comprising a replaceable rod bearing mounted in the bore in the nose end cap.

3. The invention as set forth in claim 2 wherein the rod bearing comprises a reinforced plastic material.

4. The invention as set forth in claim 1 wherein said plurality of sealing rings comprises:
(a) a pair of D-ring seals for each of the nose and back end cap bosses;
(b) a pair of packing ring seals, one disposed in an annular groove in the piston on each side of the wear band;
(c) a rod seal mounted in a counterbore in the nose end cap bore; and,
(d) a piston rod wiper seal recessed in the axially outer face of the nose end cap.

5. The invention as set forth in claim 4 wherein said plurality of sealing rings are made of a material inert to the cylinder environment.

6. The invention as set forth in claim 5 wherein the sealing ring material comprises a urethane.

7. The invention as set forth in claim 1 wherein said sealing rings require no lubrication in service.

8. The invention as set forth in claim 1 comprising a signal generator attached to the piston and a position sensor on the outside of the cylinder operative to generate a signals representative of an extended position and a retracted position of the piston.

9. The invention as set forth in claim 8 wherein the signal generator comprises a magnetic material attached to the piston head and the sensor comprises a proximity switch.

10. The invention as set forth in claim 1 wherein said back end cap is selected from a pair of back end caps having different lengths in the direction of the cylinder axis.

11. The invention as set forth in claim 10 including a common cylinder head adapted to mount directly on either of said back end caps to direct compressed air from a supply to the cylinder.

12. The invention as set forth in claim 1 wherein said piston comprises a unitary metal piston head.

13. The invention as set forth in claim 12 wherein the piston rod is demountably connected to the piston head.

14. A method for rebuilding, without machining, a pneumatic cylinder for a railroad track switch operator, said cylinder being of a type including a cylinder tube enclosed at opposite ends by a back end cap and a nose end cap, said end caps interconnected with a plurality of demountable tie rods, a piston including a piston head mounted for reciprocal movement in the cylinder tube and a piston rod extending axially through a bore in the nose end cap, and sealed interfaces between the cylinder tube and the end caps, the OD of the piston and the ID of the cylinder tube, and the nose end cap bore and the piston rod, the method comprising the steps of:
(1) providing each of said interfaces with replaceable annular seals;
(2) providing a replaceable cylinder tube of a composite plastic material;
(3) providing a replaceable annular wear ban for the interface between the piston head and the cylinder tube;
(4) demounting the tie rods and disassembling the end caps and piston from the cylinder tube;
(5) removing and replacing the seals and the wear band;
(6) replacing the cylinder tube; and,
(7) reassembling the cylinder.

15. The method as set forth in claim 14 including the steps of:
(1) providing the interface between the bore in the nose end cap and the piston rod with a replaceable rod bearing; and,
(2) replacing said rod bearing during disassembly.

16. The method as set forth in claim 14 wherein the interfaces between the cylinder tube and the end caps comprise opposed annular bosses on said end caps sized to be received in said opposite tube ends, and including the step of providing the interfaces between the cylinder tube and each of the end cap bosses with a pair of D-ring seals received in annular grooves in said bosses.

17. The method as set forth in claim 14 including the step of providing the interface between the piston head and the cylinder tube with a pair of packing ring seals, one disposed in an annular groove in the piston head on each side of the wear band.

18. The method as set forth in claim 14 including the step of providing the interface between the nose end cap bore and the piston rod with a rod seal and a rod wiper seal mounted in said bore.
